(19) United States
(12) Patent Application Publication
(10) Pub. No.: US 2008/0076587 A1
(43) Pub. Date: Mar. 27, 2008

(54) Flange shouldered screw-in stub shaft

(75) Inventors: Thomas S. Cufr, Gainesville, GA (US); Barron D. Grant, Gainesville, GA (US); Cecil L. Baird, Gainesville, GA (US)

Correspondence Address: THOMPSON COBURN, LLP, ONE US BANK PLAZA, SUITE 3500, ST LOUIS, MO, 63101, US

(73) Assignee: Reliance Electric Technologies, LLC

(21) Appl. No.: 11/526,423

(22) Filed: Sep. 25, 2006

(51) Int. Cl. F16C 3/00

(52) U.S. Cl. 464/182

(57) ABSTRACT

A stub shaft arrangement is provided for mounting loads on rotary shafts, such as the rotor shaft of an electric motor. The stub shaft has a load mounting extension, a threaded extension, and a shoulder disposed therebetween. The threaded extension is designed to interface with a threaded bore of a rotary shaft to secure the stub shaft in place. The shoulder bears tightly against an outer or end surface of the rotary shaft to resist overhung loads on the stub shaft. The arrangement of the shoulder permits a greater distance to be obtained for a moment that resists the loading.

### BACKGROUND

The present invention relates generally to mechanical power transmission devices, and more particularly to an arrangement for supporting an overhung load, such as a sensor or encoder on a motor shaft.

A wide variety of equipment is known and in use for transmitting controlled rotary power to loads. In many such arrangements an electric motor drives the load, coupled to the load via an output shaft and coupling. Certain types of application require additional outputs for both conveying rotary power to other loads, and for providing feedback used in the control of the electric motor. Such additional outputs may be provided by designing a double-ended rotor shaft, or by adding shaft components to one end of the rotor.

In one exemplary application, a position feedback device, such an encoder, can be mounted on an end of an electric motor opposite a primary powered application. The application may include, for example, a driven pump, pulley, or any other load which is powered by the electric motor. On an opposite end, the motor may be provided with a second extension which is either an integral part of the rotor shaft, or is added to the rotor shaft for the particular application.

Where extensions, typically referred to in the industry as stub shafts, are added to a rotor shaft, a particular difficulty exists in maintaining axially alignment of the stub shaft with the rotor shaft during use. Misalignment can cause wear on the motor bearings, as well as on the device mounted on the stub shaft. Over time, misalignment can result in excessive vibration of both the motor, the overhung load device, and of all of the components of these, ultimately resulting in premature failure of one or both devices.

There is a need, therefore, for an improved technique for mounting overhung loads, such as sensors, transducers, positioning coders, and so forth on motor stub shafts that more effectively resists moments of the overhung loads and thereby avoids such excessive vibration, misalignment, wear and ultimate failure.

### BRIEF DESCRIPTION

The present invention provides a novel approach to stub shaft mounting designed to respond to such needs. The technique may be used for a wide range of rotary actuators, but it is particularly well-suited to use with electric motors. Moreover, the stub shaft can be used for mounting a wide range of loads, including sensors, such as position encoders. It should be noted that other loads, such as pulleys, sheaves, and so forth can also be mounted in the manner provided by the invention.

In accordance with certain aspects of the invention, a stub shaft is provided that is threaded into a threaded bore of a rotary shaft, such as a rotor shaft of an electric motor. An end face of the rotary shaft is provided about the threaded bore, and may be generally perpendicular to an axial center line of the shaft. The stub shaft includes a threaded extension that enters into and is threaded into the threaded bore. A shoulder of the stub shaft is configured to abut the end surface of the rotary shaft. As the stub shaft is tightened into engagement into the rotary shaft, then, contact between the shoulder and the end-surface of the rotary shaft establishes a tight fit and resists misalignment and extraction of the stub shaft from the rotary shaft over time.

### DRAWINGS

These and other features, aspects, and advantages of the present invention will become better understood when the following detailed description is read with reference to the accompanying drawings in which like characters represent like parts throughout the drawings, wherein:

FIG. 1 is an elevational view of an exemplary motor having a load, in this case a position encoder, mounted on a stub shaft in accordance with aspects of the invention;

FIG. 2 is an exploded view of certain of the components illustrated in FIG. 1 showing the location of the stub shaft in the assembly;

FIG. 3 is an exemplary stub shaft arrangement in accordance with the prior art; and

FIG. 4 is an elevational view of an exemplary stub shaft in accordance with aspects of the present technique mounted in a rotor of an actuator such as an electric motor.

### DETAILED DESCRIPTION

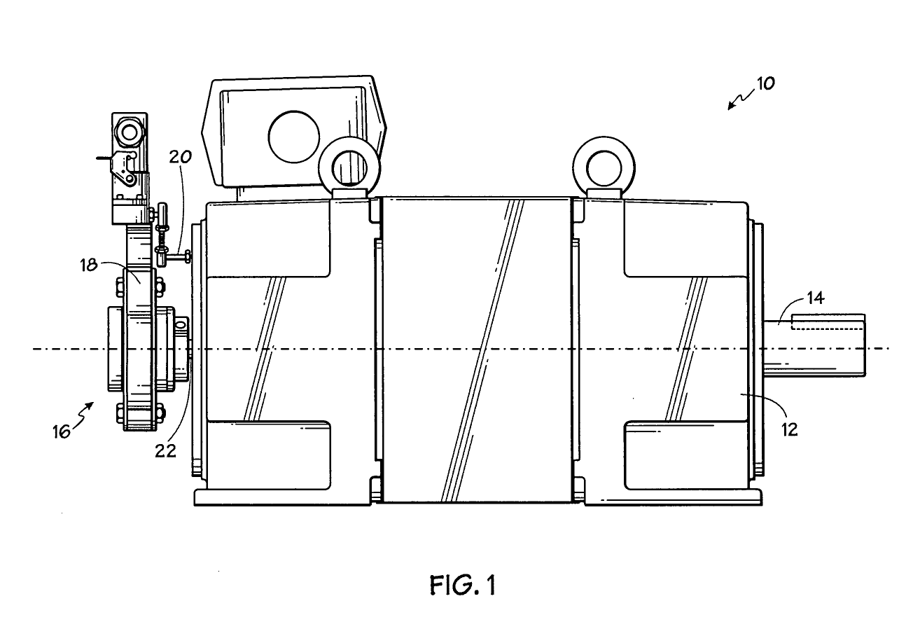

Turning now to the drawings, and referring first to FIG. 1, a power transmission system 10 is generally illustrated as including an electric motor 12. The electric motor may be used for any range of driven loads, such as pumps, conveyers, fans, and so forth. As will be appreciated by those skilled in the art, the motor generally includes an external frame or housing that will hold a stator (not shown), as well as a rotationally supported rotor (not shown). The rotor shaft 14 extends from one end of the motor for coupling the motor to a driven load. Electrical service may be provided to the motor in any conventional manner. In general, the motor may be single or three-phase, and various types of frames, shafts, mounting arrangements, and so forth may be envisaged. It should also be noted that the stub shaft arrangement of the invention, described in greater detail below, is not necessarily limited to use on electric motors, but may find use on other types of rotary actuator shafts.

Motor 12 is designed to support an overhung load 16 at an end thereof opposite from the shaft end 14. In the illustrated embodiment, load 16 includes an encoder 18 that generates a position or velocity signal that can be transmitted to a remote monitoring or control system (not shown) for regulating operation of the motor. As will be appreciated by those skilled in the art, such encoded information is often useful for regulating speeds, torques, and other electrical and/or mechanical characteristics of the output of the motor. In the illustrated embodiment, the encoder also includes an anti-rotation linkage 20 that is mechanically coupled to the frame of the motor. The linkage 20 prevents the encoder from rotating with the shaft during operation. The encoder itself is mounted on the common shaft of the rotor of the electric motor via a stub shaft 22 shown and described in greater detail below.

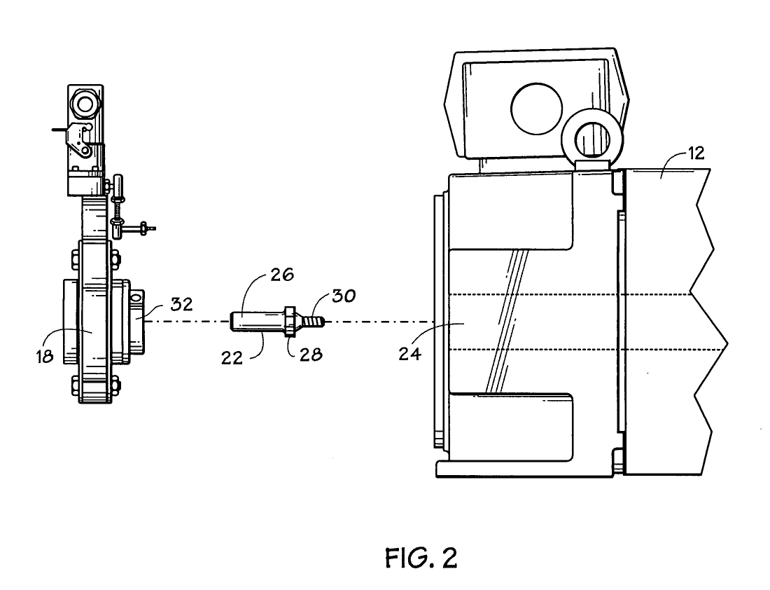

FIG. 2 illustrates the assembly of FIG. I with the encoder 18 exploded out to the left and the stub shaft 22 illustrated as disposed between the motor and the encoder. As shown in FIG. 2, the motor 12 has a rotor shaft 24 (the end of which is shown in detail in FIG. 4 below), configured to receive the stub shafts 22. The stub shaft itself has a load mounting extension 26 adjacent to a shoulder 28. A threaded extension 30 is provided adjacent to the shoulder on a side of the stub shaft that is received in the rotor shaft 24. The threaded extension 30 has threads that interface with threads of the rotor shaft, as described below, to hold the stub shaft tightly engaged in service. The shoulder 28 is designed to bear against an outer surface of the motor shaft, as also described below. One or more wrench flats may be provided on the shoulder 28 to allow it to be tightly engaged in the rotor shaft and removed for service or replacement. The load mounting extension 26, in the illustrated embodiment, is a straight cylindrical shaft, although such shafts will typically be keyed, splined or otherwise configured to cause rotation of the load with the rotor shaft. In the illustrated embodiment, encoder 18 includes a mounting hub 32 designed to surround a portion of extension 26 and support the encoder, as well as cause rotation of components of the encoder during use.

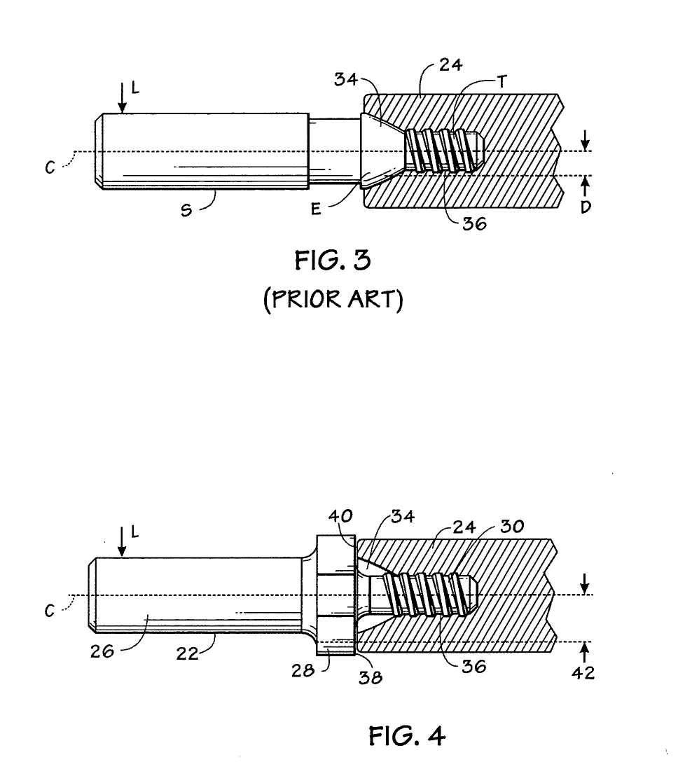

FIG. 3 is a detailed view of an end of an electric motor rotor shaft in which a stub shaft in accordance with certain prior art designs is shown mounted. As can be seen in FIG. 3, the rotor shaft 24 has a tapered opening 34 adjacent to a threaded bore 36. The prior art stub shaft is threaded into the motor shaft by means of a threaded extension T. A tapered extension E on the stub shaft is received in the tapered opening 34 and generally corresponds in geometry to the tapered opening. A shaft extension S extends from the tapered extension and is designed to receive a load. As indicated by the reference L, the load is an overhung load which causes a moment exerted at the point of application of the load. As will be appreciated by those skilled in the art, this moment is countered by cyclic loading of the stub shaft as it rotates with the motor shaft. In the illustrated prior art design, the moment resisting the cyclic load acts at an effective distance D located approximately mid-way along the tapered extension E from the center line C of the stub shaft. It has been found that such arrangements do not adequately support overhung or cantilevered loads on the rotational stub shaft, and the tapered surfaces can become loose or worn over time, ultimately resulting in excessive vibration and even failure of the assembly.

FIG. 4 shows an exemplary stub shaft in accordance with the invention, and as illustrated more generally in FIG. 2 above. For compatibility reasons, the shaft may be designed to interface with rotary shafting essentially identical to that used with prior art arrangements. Such shafting, again, includes an opening 34 adjacent to which a threaded bore 36 is located. In the inventive stub shaft, however, shoulder 28 is substantially larger than the opening 34 in the rotor shaft. Opening 34 may be tapered as in prior art arrangements, such as to aid in centering and assembling the stub shaft in the rotor shaft, or may be provided with a smaller chamfer, where desired. The shoulder of the stub shaft includes a surface 38 that is generally perpendicular, in the illustrated embodiment, to the center line C of the stub shaft. In certain arrangements, the surface 38 may be contoured other than simply perpendicular to this center line. An end face or surface of the rotary shaft 24 is provided with a conforming geometry, in this case generally perpendicular to the center line C. This interface 40 is designed to contact the face 38 of the stub shaft when the stub shaft is installed in the rotary shaft. The stub shaft if tightly engaged by cooperation of the threaded extension 30 with the threads of the bore 36 until tight engagement is obtained between surface 38 and 40.

As will be appreciated by those skilled in the art, the provision of shoulder 28 and the interaction of surfaces 38 and 40 allow for significant improvement in resisting the moments applied by the load L. In particular, as illustrated in FIG. 4, the point of application of the resisting moment is moved substantially radially outwardly, as indicated generally by reference numeral 42. It has been found that the reconfiguration of the stub shaft to provide for interfacing with the rotary shaft substantially more distal from the center line of the stub shaft greatly enhances the ability to resist the overhung load, eventual vibration, and the withdrawal of the stub shaft from the rotary shaft.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A stub shaft comprising:
a threaded extension configured to be received in a threaded bore of a rotary shaft;
a mounting extension co-axial with the threaded extension and configured to receive a driven load; and
a shoulder portion disposed between the threaded extension and the mounting extension, the shoulder having a load surface configured to contact an outer end surface of the rotary shaft around the threaded bore to support a moment resisting loading by the driven load.

2. The stub shaft of claim 1, wherein the mounting extension is configured to support an overhung load.

3. The stub shaft of claim 1, wherein the load surface of the shoulder is substantially perpendicular to a central axis of the stub shaft.

4. The sub shaft of claim 1, wherein the shoulder includes a plurality of wrench flats around an outer periphery thereof.

5. A stub shaft system comprising:
a rotary shaft having an inner threaded bore extending along a central axis thereof, and an outer end surface surrounding the threaded bore; and
a stub shaft having a threaded extension configured to be received in the threaded bore of the rotary shaft, a mounting extension co-axial with the threaded extension and configured to receive a driven load, and a shoulder portion disposed between the threaded extension and the mounting extension, the shoulder having a load surface configured to contact the outer end surface of the rotary shaft around the threaded bore to support a moment resisting loading by the driven load.

6. The system of claim 5, wherein the rotary shaft is a rotor shaft of an electric motor.

7. The system of claim 6, wherein an end of the rotor shaft opposite the threaded bore has an external extension configured for driving a primary load.

8. The system of claim 5, wherein the stub shaft is configured to support an overhung load on the mounting extension.

9. The system of claim 5, wherein the load surface of the shoulder is substantially perpendicular to a central axis of the stub shaft.

10. The system of claim 5, wherein the stub shaft is configured to support the load by resisting a moment caused by the load by contact of the load surface of the shoulder portion with the outer end surface of the rotary shaft.

11. The system of claim 5, wherein the shoulder includes a plurality of wrench flats around an outer periphery thereof.

12. A stub shaft system comprising:
a rotary shaft having an inner threaded bore extending along a central axis thereof, and an outer end surface surrounding the threaded bore;
a stub shaft having a threaded extension configured to be received in the threaded bore of the rotary shaft, a mounting extension co-axial with the threaded extension, and a shoulder portion disposed between the threaded extension and the mounting extension, the shoulder having a load surface configured to contact the outer end surface of the rotary shaft around the threaded bore; and
a load coupled to the mounting extension.

13. The system of claim 12, wherein the rotary shaft is a rotor shaft of an electric motor.

14. The system of claim 13, wherein an end of the rotor shaft opposite the threaded bore has an external extension configured for driving a primary load.

15. The system of claim 13, wherein the load is an overhung load supported by the mounting extension.

16. The system of claim 15, wherein the load includes an anti-rotation linkage coupled to a housing of the electric motor to prevent rotation of the load during operation.

17. The system of claim 12, wherein the load includes a position or speed encoder.

18. The system of claim 12, wherein the stub shaft is configured to support the load by resisting a moment caused by the load by contact of the load surface of the shoulder portion with the outer end surface of the rotary shaft.

19. The system of claim 12, wherein the load surface of the shoulder is substantially perpendicular to a central axis of the stub shaft.

20. The system of claim 12, wherein the shoulder includes a plurality of wrench flats around an outer periphery thereof.
